(19) United States
(12) Patent Application Publication
(10) Pub. No.: US 2025/0341280 A1
(43) Pub. Date: Nov. 6, 2025

(54) STORAGE AND REUSE OF HYDROGEN AND OXYGEN PRODUCED BY GREEN ENERGY IN GROUNDWATER

(71) Applicants: Milán Dániel PALKOVICS, Dunaújváros (HU); Károly GYORBÍRÓ, Budapest (HU); Attila KÁTAI, Budapest (HU); András MELEGHEGYI, Vecsés (HU)

(72) Inventors: András MELEGHEGYI, Vecsés (HU); Dániel HARSÁNYI, Budapest (HU)

(21) Appl. No.: 18/866,456

(22) PCT Filed: Jul. 16, 2023
(86) PCT No.: PCT/IB2023/057256

§ 371 Date: Nov. 15, 2024

(30) Foreign Application Priority Data
May 17, 2022 (HU) P2200161

(51) Int. Cl. F17C 1/00; C25B 1/04

(52) U.S. Cl. CPC F17C 1/007; C25B 1/04; F17C 2201/0109; F17C 2221/011; F17C 2221/012; F17C 2227/0135; F17C 2270/0142

(57) ABSTRACT

The storage apparatus according to the invention, a geo hydrogen storage system, is a system consisting of a plurality of groundwater wells drilled into the ground. Hydrogen is produced by electrolysis using green energy. The hydrogen and the associated oxygen are stored in and recovered from cartridges installed in said wells being flooded by the groundwater and located at appropriate distances from each other. The system uses closed-circuit circulating water to transport the gases generated in electrolysis in the form of bubbles. The gases are separated from the circulating water by volume expansion and form gas bubbles when they reach the corresponding cartridge. This gas bubble will, with continued operation, squeeze larger and larger volume of water from the groundwater in the cartridge, thereby pressurizing the system.

### FIELD OF THE INVENTION

The invention is a hydrogen and/or oxygen storage system, a storage apparatus, that uses groundwater as an energy storage facility.

### STATE OF THE ART

Hydrogen is widely known as an energy carrier and is currently stored in a variety of ways. Such solutions allow solar energy to be stored and converted back when solar energy is not available.

Storage plays a critical role in the use of hydrogen for energy. Current common storage processes are implemented as gaseous, liquid or simple hybrids.

By 2050, human energy demand is estimated to triple compared to the millennium, making the exploration of alternative energy sources increasingly urgent and essential.

One of the key issues to be addressed is to drastically reduce greenhouse CO2 emissions. In the last two decades, there has been a lot of interest in the integration of hydrogen into the energy sector, which could be the basis for building a hydrogen-based energy economy.

The concept is to use hydrogen produced from different alternative energy sources (solar, geothermal, wind, biomass, etc.) in so-called fuel cells, in which an electrochemical reaction converts the chemical energy stored in the hydrogen into electrical energy.

Since the hydrogen generated can be both spatially and temporally distant from the place of use, it must be stored.

The invention aims at providing a low-cost solution for the intermittent storage of energy in hydrogen along with minimizing maintenance and servicing costs, whether for domestic or large power plants.

### Bried Description of the Invention

The additional objectives which can be understood or deduced from the above and the remainder of the present disclosure have been addressed by an apparatus according to claim 1, preferred embodiments of which are defined in claims 2 to 4.

### BRIEF DESCRIPTION OF THE DRAWING

FIG. 1 schematically illustrates a preferred exemplary embodiment of an apparatus according to the invention.

### DETAILED DESCRIPTION OF THE INVENTION

The apparatus according to the invention is particularly suitable for installation in areas where the soil can be drilled without significant costs using conventional well drilling techniques and groundwater can be extracted.

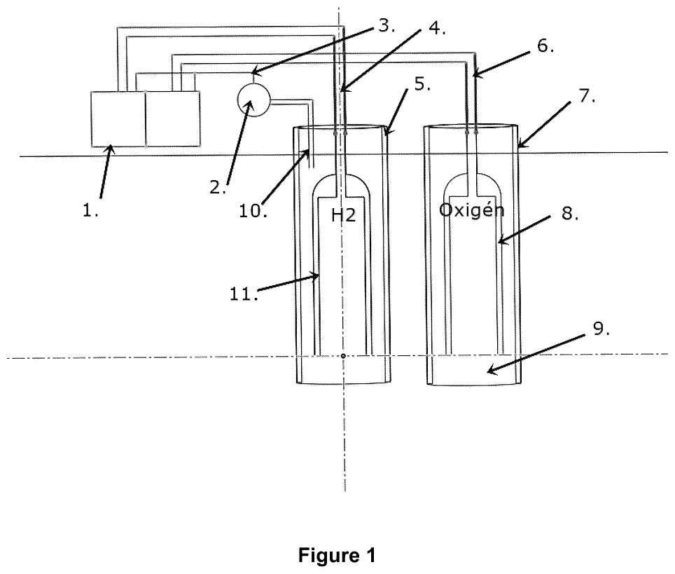

For one practical embodiment of the invention, one or more wells 5, 7, each preferably 310 mm or more in diameter, are drilled using conventional technology, the depth(s) of which is/are preferably always the maximum depth that can be drilled in the field from an economic point of view. As shown in FIG. 1, a vessel or a cartridge 11, 8 closed at the top and sides but open at the bottom is installed in each well 5, 7 below the level of groundwater 9 in the respective well 5, 7, at a safe distance below said level of groundwater 9, Said cartridge is preferably fixed to the side of the well 5, 7. The 11, 8 cartridges are held in a central position within the well 5, 7 by spacers.

A rated circulating pump 2 is installed in one of the wells 5 of the well system prepared. The circulating pump 2 will circulate the water from the well 5 through a suction pipe 10 relative to the water level in the well 5 from a safe depth into and through a two-chamber electrolysis tank 1 forming an electrolyzer, known to a skilled artisan, in such a way that two closed water systems 3 are formed upstream said tank 1 by branching said suction pipe 10 in two directions.

Water pipes 4, 6 returning from the electrolysis tank 1 to the wells 5, 7, respectively, are each connected to a top connection point of the cartridges 11 and 8 arranged in the well 5 (for hydrogen) and the well 7 (for oxygen), respectively. At a top section of each of the cartridges 11, 8 for hydrogen and oxygen, respectively, at a connection point of the corresponding return water pipes 4, 6, the pipe cross-section increases, which allows the gas/gases to be trapped below the water level.

The two closed water systems 3, which get formed when the circulating pump 2 is primed and which suck up the water from the well 5, return the water that has been at least partially electrolyzed through the electrolysis tank 1 to the cartridges 11, 8 in the wells 5, 7. Circulation is continuous.

Start-up and energy recovery of the system are controlled by appropriate electronics.

When green energy, preferably produced by solar panels, wind generators, etc., is available, a direct (DC) current provided by said green energy is fed to negative and positive points of the electrolysis tank 1. In the electrolysis tank 1, hydrogen and oxygen are generated by the DC current by means of the well-known electrolysis process of water under continuous circulation of water. Since the electrode arranged in the electrolysis tank 1 is a perforated stainless-steel plate, the gases formed, in the form of bubbles, are carried away by the water stream from the corresponding (i.e., positive or negative) side of the tank 1 through the return pipes 4, 6 to the corresponding cartridge 11, 8, where said gases get separated from the water.

In the cartridge 11, 8, the increased cross-section causes hydrogen and oxygen, respectively, to accumulate and thus the gases start to displace the groundwater from the hydrogen/oxygen cartridge. Since the water flow is continuous, the gases cannot oppose the water and continuously accumulate in the cartridges 11, 8. As the amount of gas accumulating increases, the groundwater 9 flows continuously out from the cartridges 11, 8 into the bottom of the wells 5, 7.

When a cartridge 11, 8 fully fills with gas, the system switches to the next cartridge in the next well using a suitable interposed valve system known to the skilled artisan.

The gas (i.e., hydrogen or oxygen) trapped in the cartridges 11, 8 of the wells 5, 7 is compressed by the pressure of the groundwater 9 corresponding to the depth of the well, allowing an easy recovery of the gas and thus its subsequent use.

As the system has very few moving parts and the pressure is maintained by the soil structure, the storage apparatus according to the invention requires minimal maintenance.

The invention primarily converts recovered hydrogen into electricity using a fuel cell, but it can also be used to power a hydrogen turbine or to use the recovered hydrogen and oxygen in other ways. It is also clear to the skilled artisan that the storage apparatus according to the invention is suitable for both the storage and the subsequent use of such gases other than hydrogen and oxygen which do not react with water.

### SUMMARY

The invention provides a solution for temporary storage of hydrogen and oxygen produced, for example, from green energy, at a significantly lower cost than existing solutions. The apparatus consists of a single circulating water pump, and therefore both construction and operating costs are much lower than for conventional gas storage solutions.

As the depth of the wells increases, the pressure of the stored gas can be adjusted due to the increase in hydrostatic pressure; thus, recovery is also simple and does not generate further costs.

When filling the wells with gas, only the energy consumption of the circulating pump should be taken into account, and it is therefore significantly cheaper than other systems with tank.

Because of the pressure due to surrounding ground and the hydrostatic pressure, no loss of the pressure holding capacity of the tanks over time appears because the gas cartridges are not subject to extreme pressure changes-therefore they have a long lifetime.

With the solution according to the invention, a significant amount of gas can be stored in an area of suitable soil structure and recovered in a suitable period of time when there is a need for it.

### LIST OF REFERENCE SYMBOLS

1 (electrolysis) tank
2 circulating pump
3 (closed) water system
4 pipe (for return water mixed with hydrogen)
5 well
6 pipe (for return water mixed with oxygen)
7 well
8 (internal oxygen) cartridge
9 groundwater
10 suction pipe (of the circulating pump)
11 (internal hydrogen) cartridge

1. A storage system for underground storage of gas, the system comprising:
an energy source;
an electrolyzer for water electrolysis using energy of the energy source, the electrolyzer having two chambers, an anode chamber and a cathode chamber, wherein:
the anode chamber is configured to accommodate oxidation reaction of water thereby producing oxygen therein and equipped with a first inlet and a first outlet;
the cathode chamber is configured to accommodate reduction reaction of water thereby producing hydrogen therein and equipped with a second inlet and a second outlet;
at least two wells (5, 7), individually comprising:
an interior filled with groundwater (9) up to a level of groundwater (9), and a cartridge (11, 8) having a closed end, an open end opposite to the closed end, and a closed side extending between the closed end and the open end, the side and the closed end and the open end forming a cartridge chamber;
the cartridge (11, 8) being fixed into the interior of the well (5, 7) under a groundwater (9) level in a position in which the closed end is located closer to the groundwater (9) level than the open end;
a circulating pump (2) with a pump inlet and a pump outlet, the pump inlet being in fluid communication with the interior of one of the at least two wells (5, 7) through a suction pipe (10) terminating under the groundwater (9) level of the one of the at least two wells (5, 7), the pump outlet being in fluid communication with the first inlet of the anode chamber and the second inlet of the cathode chamber to form a closed water circulation system, wherein:
the first outlet of the anode chamber is in fluid communication with the cartridge chamber of one of the cartridges (8) through an anode pipe (6) passing through the closed end of the respective cartridge (8);
the second outlet of the cathode chamber is in fluid communication with the cartridge chamber of an other one of the cartridges (11) through a cathode pipe (4) passing through the closed end of the respective cartridge (11); and
wherein the cartridges (8, 11) are configured to store one of gaseous hydrogen and oxygen produced by the electrolyzer, in use, against a hydrostatical pressure of groundwater (9) in a respective one of the at least two wells (5, 7).

2. The storage system according to claim 1, wherein the energy source is an alternative energy source selected from a group consisting of solar plants, geothermal plants, wind farms, and biomass plants.

3. The storage system according to claim 1, wherein one of the at least two wells (5, 7) is a drilled well or a dug well.

4. The storage system according to claim 1, wherein the anode pipe (6) and the cathode pipe (4) is formed with an increase in cross-section within the respective cartridge (11, 8) so as to allow any gaseous hydrogen and oxygen to be trapped in the respective cartridge (11, 8) below the groundwater (9) level.
